(19) United States
(12) Patent Application Publication
(10) Pub. No.: US 2014/0081804 A1
(43) Pub. Date: Mar. 20, 2014

(54) SOCIAL PURCHASE SYSTEM

(71) Applicant: Frank Anthony Nuzzi, Pflugerville, TX (US)

(72) Inventor: Frank Anthony Nuzzi, Pflugerville, TX (US)

(73) Assignee: EBAY INC., San Jose, CA (US)

(21) Appl. No.: 13/623,482

(22) Filed: Sep. 20, 2012

(51) Int. Cl. G06Q 20/12

(52) U.S. Cl. 705/26.41

(57) ABSTRACT

Systems and methods for providing social purchases include hardware and software configured to receive a purchase instruction from a purchaser that includes an item and a merchant associated with the item. The purchase instruction is determined to be associated with a social purchase request that may be predefined or provided along with the purchase instruction. In response to determining the associated social purchase request, a social purchase solicitation including the item is provided to a plurality of friends connected to the purchaser through a social network on their associated social network profiles. The social purchase solicitation is monitored for social purchase opinions directed to the item by the plurality of friends through the social network profiles. A payment request to make a payment from the purchaser to the merchant is sent in response to the social purchase opinions including a predetermined number of positive opinions directed to the item.

### BACKGROUND

1. Field of the Invention

The present invention generally relates to online and/or mobile payments and more particularly to a social purchase system.

2. Related Art

More and more consumers are purchasing items and services over electronic networks such as, for example, the Internet. Consumers routinely purchase products and services from merchants and individuals alike. The transactions may take place directly between a conventional or on-line merchant or retailer and the consumer, and payment is typically made by entering credit card or other financial information. Transactions may also take place with the aid of an on-line or mobile payment service provider such as, for example, PayPal, Inc. of San Jose, Calif. Such payment service providers can make transactions easier and safer for the parties involved. Purchasing with the assistance of a payment service provider from the convenience of virtually anywhere using a mobile device is one main reason why on-line and mobile purchases are growing very quickly.

Purchasers today are typically presented with many options from which to choose to make a purchase of a desired product, product type, service, or service type. For example, for any given product type, the purchaser may be presented with a plurality of products from one or more merchants, manufacturers, and/or other product providers. Making the decision of which of those products to purchase may be difficult for even the most conscientious purchaser. In some situations, the purchasers may wish to solicit the opinions of trusted and/or knowledgeable friends about the product in order to help make the purchasing decision. Such solicitations are time-consuming and complicated, as the purchasers is required to select one or more products from a number of options, determine the appropriate friends with sufficient knowledge about the product, contact each of those friends separately, provide the details of the selected product(s) to each friend, and then wait for a response from each friend. Furthermore, the friends contacted by the purchaser may feel rushed in providing their opinion immediately upon being contacted, and thus may provide an incomplete or unresearched opinion that may direct the purchaser to a product unsuitable for that purchaser. Upon retrieving the opinions of the contacted friends, the purchaser is then required to filter through those opinions to make a purchasing decision, and then go back to the merchant or manufacturer selling the product to make the purchase. Typically, purchasers will forego such solicitations or will only solicit a minimal number of friends for an opinion about the product, which fails to leverage all of the purchaser's friends that may have relevant knowledge of the product.

Thus, there is a need for an improved purchasing system.

### BRIEF DESCRIPTION OF THE FIGURES

FIG. 1 is a flow chart illustrating an embodiment of a method for providing a social purchase;

FIG. 2 is a front view illustrating an embodiment of a purchaser device displaying a social purchase set-up page;

FIG. 3 is a front view illustrating an embodiment of a purchaser device displaying a social purchase set-up page;

FIG. 4 is a front view illustrating an embodiment of a purchaser device displaying an item purchasing page;

FIG. 5 is a front view illustrating an embodiment of a purchaser device displaying a social purchase solicitation and a plurality of social purchase opinions;

FIG. 6 is a front view illustrating an embodiment of a purchaser device displaying a social purchase solicitation and a plurality of social purchase opinions

FIG. 7 is a schematic view illustrating an embodiment of a networked system;

FIG. 8 is a schematic view illustrating an embodiment of a computer system; and

FIG. 9 is a schematic view illustrating an embodiment of a social purchase system provider device.

Embodiments of the present disclosure and their advantages are best understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

### DETAILED DESCRIPTION

The present disclosure includes systems and methods for providing social purchases that allow a purchaser to select an item or a plurality of items and have friends in their social network ‘vote’ on the item or items to determine whether the item will be purchased or which of a plurality of items will be purchased. Social purchase requests may be predefined prior to the purchaser selecting an item or items for possible purchase, or may be provided concurrently with a purchaser's selection of an item or items for possible purchase. When a purchase instruction is received from the purchaser that includes an item, it is determined whether the purchase instruction is associated with a social purchase request. In response to determining the purchase instruction is associated with a social purchase request, a social purchase solicitation is provided to a plurality of friend social network profiles that are connected to the purchaser social network profile through a social network. The social purchase solicitation is monitored for social purchase opinions directed to the item by the plurality of friend social network profiles. A payment request to make a payment from the purchaser to a merchant selling the item may be automatically sent in response to the social purchase opinions including a predetermined number of positive opinions directed to the item.

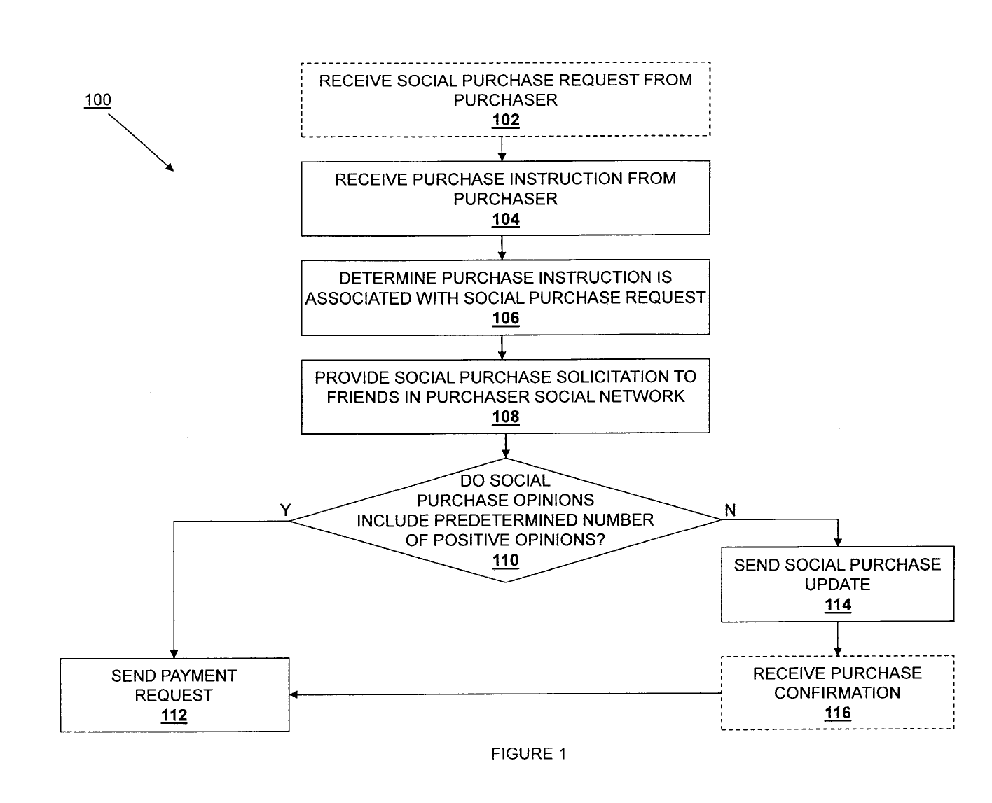

Referring initially to FIG. 1, a method 100 for providing a social purchase is illustrated. In an embodiment of the method 100 described below, an account provider may provide a purchaser with a purchaser payment account, and the purchaser may use the purchaser payment account to fund payments for purchases made from merchants. In another embodiment, a payment service provider such as, for example, PayPal, Inc. of San Jose, Calif., may assist in the making of payments from the purchaser to the merchant by transferring funds from the purchaser payment account to a merchant payment account of the merchant. However, these embodiments are meant to be merely exemplary, and one of skill in the art will recognize that a variety of modifications may be made to the social purchase system discussed below without departing from the scope of the present disclosure.

Furthermore, in an embodiment of the method 100 described below, a social network provider provides a social network that connects a purchaser with a plurality of friends through connections between a purchaser social network profile (a “purchaser profile”) and a plurality of respective friend social network profiles (“friend profiles”). As discussed below, the purchaser may divide their social network up into subgroups that include subsets of the friends connected to the purchaser through the social network, and each social network subgroup will associate the purchaser profile with a subset of the friend profiles. However, a wide variety of modification may be provided with regard to the social network system discussed herein, and one of skill in the art will recognize that any social network system will fall within the scope of the present disclosure.

Further still, the social purchase system discussed herein may be provided using a number of different devices and/or combinations of devices, and references below to a social purchase system provider device may include any of those devices. For example, the social purchase system may be provided by a purchaser device, a merchant device, an account provider device, a payment service provider device, a social network provider device, a social purchase system provider device (separate from the purchaser device, the merchant device, the account provider device, the payment service provider device, and the social network provider device) and/or combinations thereof.

Referring now to FIGS. 1, 2, and 3, the method 100 may begin at optional block 102 where a social purchase request is received from a purchaser. As discussed below, in some embodiments, the social purchase system may allow the purchaser to provide a social purchase request prior to selecting items for purchase, and that social purchase request may allow the purchaser to define which items will be subject to social purchases. In such embodiments, the purchaser may be provided a social purchase set-up page 200 on a purchaser device from a social purchase system provider device (e.g., over a network.) For example, an account provider device may provide the social purchase set-up page 200 over the network to the purchaser device, a payment service provider device may provide the social purchase set-up page 200 over the network to the purchaser device, a social network provider device may provide the social purchase set-up page 200 over the network to the purchaser device, and/or a merchant device may provide the social purchase set-up page 200 over the network to the purchaser device.

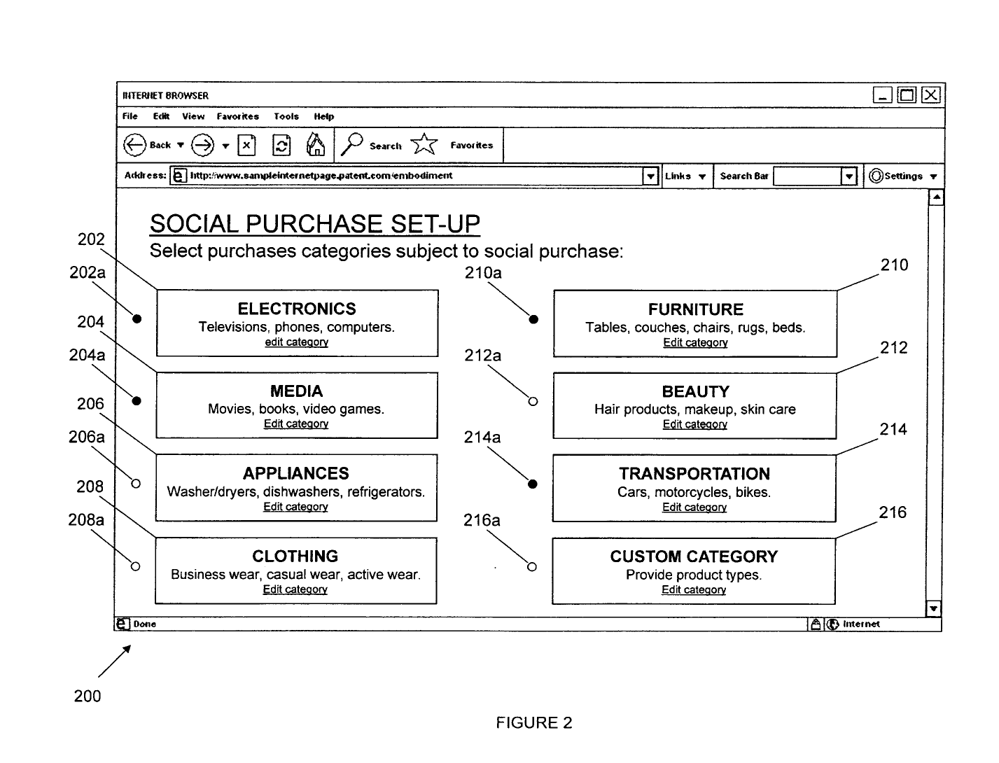

In the embodiment illustrated in FIG. 2, the social purchase set-up page 200 includes a plurality of social purchase item categories that may define categories and/or specific items that will be subject to social purchases. The social purchase set-up page 200 includes an electronics category 202, a media category 204, an appliances category 206, a clothing category 208, a furniture category 210, a beauty category 212, a transportation category 214, and a custom category 216. In the illustrated embodiment, the electronics category 202 is associated with distinct electronics items including televisions, phones, and computers, and may be editable by the purchaser to add or remove electronics items to or from the electronics category 202. However, in other embodiments, the electronics category 202 may be used to subject any electronics item to social purchases. In the illustrated embodiment, the media category 204 is associated with distinct media items including movies, books, and video games, and may be editable by the purchaser to add or remove media items to or from the media category 204. However, in other embodiments, the media category 204 may be used to subject any media item to social purchases.

In the illustrated embodiment, the appliances category 206 is associated with distinct appliance items including washer/dryers, dishwashers, and refrigerators, and may be editable by the purchaser to add or remove appliance items to or from the appliance category 206. However, in other embodiments, the appliance category 206 may be used to subject any appliance item to social purchases. In the illustrated embodiment, the clothing category 208 is associated with distinct clothing items including business wear, casual wear, and active wear, and may be editable by the purchaser to add or remove clothing items to or from the clothing category 208. However, in other embodiments, the clothing category 208 may be used to subject any clothing item to social purchases. In the illustrated embodiment, the furniture category 210 is associated with distinct furniture items including tables, couches, chairs, rugs, and beds, and may be editable by the purchaser to add or remove furniture items to or from the furniture category 210. However, in other embodiments, the furniture category 210 may be used to subject any furniture item to social purchases.

In the illustrated embodiment, the beauty category 212 is associated with distinct beauty items including hair products, makeup, and skincare, and may be editable by the purchaser to add or remove beauty items to or from the beauty category 212. However, in other embodiments, the beauty category 212 may be used to subject any beauty item to social purchases. In the illustrated embodiment, the transportation category 214 is associated with distinct transportation items including cars, motorcycles, and bikes, and may be editable by the purchaser to add or remove transportation items to or from the transportation category 214. However, in other embodiments, the transportation category 214 may be used to subject any transportation item to social purchases. In the illustrated embodiment, the custom category 216 allows the purchaser to create a custom social purchase item category 216 and/or add or remove items to or from that customer social purchase item category 216.

At block 102, the purchaser may use the purchaser device to select social purchase item categories in order to subject items that fall within the scope of those categories and/or items specifically listed in those categories to social purchases by, for example, selecting the selectors 202a, 204a, 206a, 208a, 210a, 212a, 214a, and 216a associated with the desired categories 202, 204, 206, 208, 210, 212, 214, and 216, respectively. Furthermore, the purchaser may use the purchaser device to edit the social purchase item categories such that the purchaser defines the specific items that will be subject to social purchases. In the illustrated embodiment, the purchaser has selected the electronics category 202 with televisions, phones, and computers subject to social purchases, the media category 204 with movies, books, and video games subject to social purchases, the furniture category 210 with tables, couches, chairs, rugs, and beds subject to social purchases, and the transportation category 214 with cars, motorcycles, and bikes subject to social purchases. As discussed in further detail below, when the purchaser attempts to purchase items subject to social purchases according to the selections made on the social purchase set-up page 200, the social purchase system and method may “hold” those purchase (e.g., delay transferring payment from the purchaser to the merchant selling the item) subject to an “approval” by friends in the social network of the purchaser.

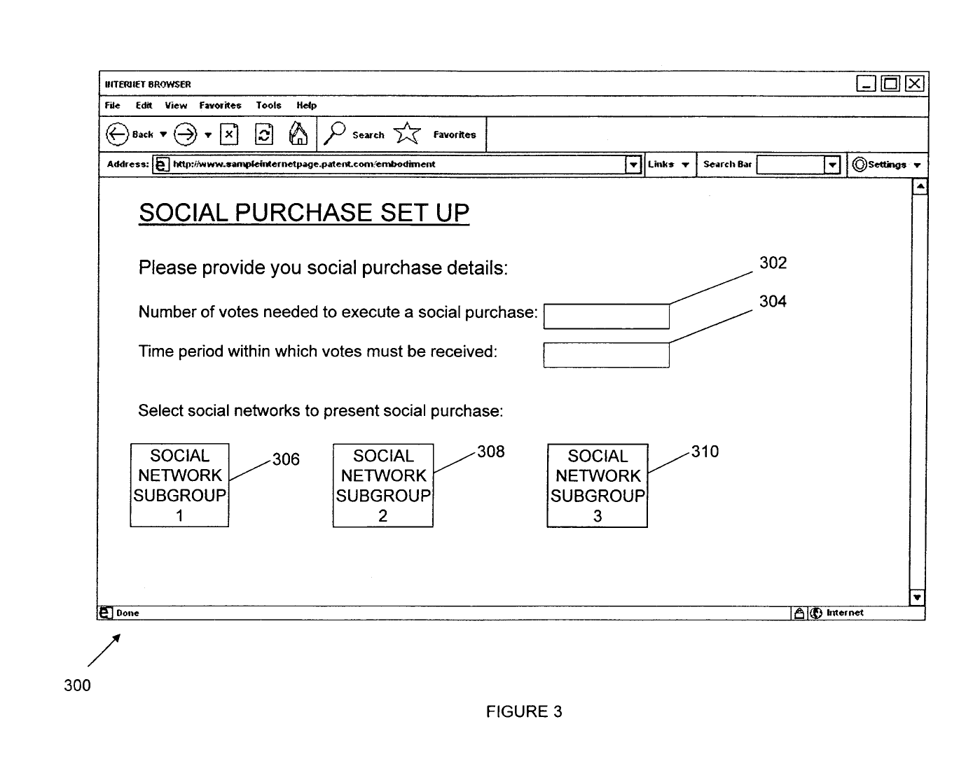

Referring now to FIG. 3, upon selecting the social purchase item categories on the social purchase set-up page 200 to define the items or item types subject to social purchases, the purchaser may be provided with a social purchase set-up page 300 from the social purchase system provider device over the network. For example, an account provider device may provide the social purchase set-up page 300 over the network to the purchaser device, a payment service provider device may provide the social purchase set-up page 300 over the network to the purchaser device, a social network provider device may provide the social purchase set-up page 300 over the network to the purchaser device, and/or a merchant device may provide the social purchase set-up page 300 over the network to the purchaser device.

The social purchase set-up page 300 allows a purchaser to define details of a social purchase that may include, for example, a number of positive opinions needed to authorize a social purchase, a time period in which the number of positive opinions must be received to authorize a social purchase, and a group of friends in the social network of the purchaser to whom a social purchase solicitation may be sent. The social purchase set-up page 300 includes a purchase authorization threshold input 302 in which the purchaser may provide a number of positive opinions (e.g., ‘votes’ in the illustrated embodiment) that must be received from friends in the social network of the purchaser in order to authorize a purchase of an item subject to a social purchase, along with a time period input 304 in which the purchaser may provide a time period within which the positive opinions must be provided in order to authorize a purchase of an item subject to a social purchase. The social purchase set-up page 300 also includes a plurality of social network subgroups 306, 308, and 310 that may include subsets of the friends in the social network of the purchaser. In some embodiments, the social purchase set-up page 300 may be provided to define the details of all social purchases requested by the purchaser. In other embodiments, the social purchase set-up page 300 may be provided for each social purchase item category selected on the social purchase set-up page 200 in order to define the details of social purchase for items in that social purchase item category. In yet other embodiments, the social purchase set-up page 300 may be provided for each item subject to a social purchase to define the details of a social purchase for that item.

While a specific example has been provided for defining social purchases according to the social purchase set-up pages 200 and 300, one of skill in the art will recognize that a wide variety of details may be provided by a purchaser to define the details of social purchases. For example, while the social purchases discussed above with regard to the social purchase set-up pages 200 and 300 has been described as directed to items being purchased, services and/or other purchases known in the art will fall within the scope of the present disclosure. In another example, while the social purchase set-up page 300 discussed above is described as defining a number of “votes” necessary to authorize a purchase, other indications of positive opinions may be used to authorize a purchase including, for example, “likes”, “+1's”, positive or non-negative comments (e.g., as determined by an analysis of the language used in the comment), and/or a variety of other indications of positive opinions known in the art. In an embodiment the time period input 304 may accept time periods (e.g., “4 days”, “2 weeks”, “1 month”, etc.), dates (e.g., “until Mar. 14, 2013”), and/or a variety of other time periods known in the art. In some embodiments, the time period input 304 may accept events that determine when social purchase opinions must be received to execute a social purchase. For example, a purchaser may include social purchase details that specify that the social purchase opinions must be received prior to a holiday (e.g., Thanksgiving, Christmas, etc.), a national event (e.g., “The Super Bowl”, “The World Cup”, etc.), a social occurrence (e.g., a friend's birthday, a friend's wedding, etc.), and/or a variety of other events known in the art. In some examples, the social purchase system provider device may retrieve that actual date or dates associated with an event to determine the details of the social purchase request by, for example, retrieving a date of the event from a database or retrieving a date of the event from a friend profile.

Furthermore, rather than requiring a predetermined number of “votes” to execute a social purchase, other techniques may be used to determine whether to execute a social purchase. In one embodiment, a percentage of positive votes along with a minimum number of votes may be used to determine whether to execute a social purchase. For example, a social purchase request may require a minimum of 10 social purchase opinions with 80% of those social purchase opinions being positive in order to execute a social purchase. However, one of skill in the art will recognize that a variety of other criteria may be associated with the social purchase request to determine whether to execute a social purchase.

While the social network subgroups 306, 308, and 310 have been described and illustrated as predefined subgroups of friends in the social network of the purchaser, the purchaser may be able to generate or provide a social network subgroup by, for example, selecting names from a list of friends in their social network in order to associate those friends with the social purchase (i.e., those friends will be involved in determining whether the purchase of an item subject to that social purchase will be made.) Furthermore, the social purchase system may be operable to automatically determine one or more social network subgroups to associate with the social network request. In an embodiment, the social purchase system provider device may search the social network of the purchaser to determine friends that may have relevant knowledge about the item or item category associated with the social purchase request. For example, the social purchase system provider device may review the friend profiles connected to the purchaser profile for interests, hobbies, and/or other friend profile information known in the art to determine which friends in the social network of the purchaser are knowledgeable about the item or item category associated with the social purchase request (e.g., if a social network request is associated with video games, the social purchase system provider device may associate a social network subgroup with that social network request that includes friend profiles that are connected to the purchase profile by a social network and that include “gaming” as an interest or hobby.)

Social network subgroups associated with social purchase requests may also be filtered by the social purchase system provider device based on the likelihood of a social purchase opinion being provided from a friend profile in that social network subgroup. In an embodiment, the social purchase system provider device may retrieve previous purchases from friend payment accounts of friend profiles connected to the purchaser profile in a social network and determine whether those previous purchases are related to the item or item category associated with the social purchase request. For example, a friend payment account that includes a recent purchase of a television may be determined to make that friend more likely to provide a social purchase opinion about a possible purchase of a television by the purchaser. In another embodiment, the social purchase system provider device may determine which of the friend profiles in a social network with the purchaser profile have provided previous social purchase opinions to determine that those friend profiles are more likely to provide a social purchase opinion about a possible purchase by the purchaser. Thus, social network subgroups associated with social purchase requests may be optimized by the social purchase system provider device to increase the likelihood that the friend profiles in that social network subgroup will provide social purchase opinions in response to a social purchase solicitation, discussed in further detail below.

In some embodiments, the social purchase system provider device may prevent friends from being part of a social network subgroup that is associated with a social purchase request more than a predetermined number of times in a predetermined time period. For example, a friend that has recently provided social purchase opinions in response to several social purchase solicitations associated with the purchaser may be prevented from being in a social network subgroup associated with a social purchase request by the purchaser even though that friend may be knowledgeable about an item or item category in the social purchase request.

In other embodiments, further information about the social purchase may be provided by the purchaser. For example, in the case of a social purchase associated with a gift, an intended recipient may be identified on a social purchase set-up page such that that intended recipient will be blocked from any communications related to the social purchase. In another example, a purchaser may define how a social purchase should be dealt with in the event that social purchase is not authorized by friends in their social network including, for example, sending a notification to the purchaser that the social purchase has not been authorized, providing the purchaser the ability to make a purchase that has not been authorized, or preventing the purchaser from making the purchase that has not authorized.

Information and details about social purchases may be stored in a database and associated with the purchasers. For example, the purchaser may have a purchaser payment account as discussed above, and the information and details provided for social purchases on the social purchase set-up pages 200 and 300 may be associated with the purchaser payment account in the database. The information and details provided for social purchases on the social purchase set-up pages 200 and 300 may also be associated with a purchaser profile, friend profiles, or an identifier for the purchaser profile or friend profiles in the database or other non-transitory memory as well.

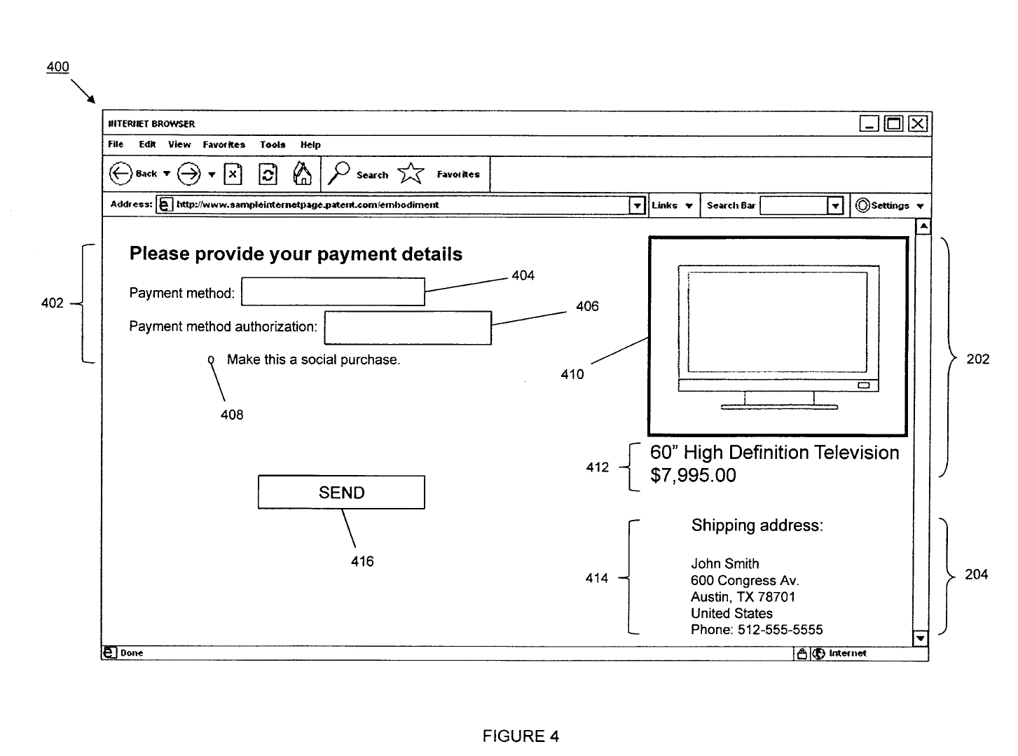

Referring now to FIGS. 1 and 4, the method 100 may either begin at or proceed to block 104 where a purchase instruction is received from the purchaser. In an embodiment, the purchaser may use the purchaser device to view items for purchase from a merchant. For example, FIG. 4 illustrates an embodiment of an item purchasing page 400 that may be part of an item purchasing website provided by a merchant device over a network to the purchaser device. As would be understood by one of skill in the art, an item purchasing website may provide a plurality of web pages that allow a purchaser to view a plurality of items, select one or more of the plurality of items, and purchase the selected item(s). The item purchasing page 400 in the illustrated embodiment is provided as part of the item purchasing website, after the purchaser has selected an item for purchase, and allows the purchaser to provide information to make a payment.

The item purchasing page 400 includes a payment details section 402 having a payment method input 404 and a payment method authorization input 406. In some embodiments, the payment details section 402 may include a social purchase selector 408 (e.g., in embodiments where optional block 102 of the method 100 is not performed, or in embodiments where the selected item is not subject to a social purchase as defined in block 102 of the method 100 but the purchaser would like that item to be subject to a social purchase.) The item purchasing page 400 also includes an item image 410 for the item selected for purchase, item details 412 for the item selected for purchase, and other purchasing details 414 associated with the item selected for purchase (e.g., the shipping details in the illustrated embodiment.) The item purchasing page 400 also includes a send button 416.

Thus, the purchaser may select an item for purchase, and then provide a payment method in the payment method input 404 and provide a payment method authorization in the payment method authorization input 406. In some embodiments, the purchaser may select the social payment selector 408. In some examples, social purchases may be an option for any payment method used by the purchaser (e.g., when a merchant or social network provider provides the social purchase system), while in other embodiments, social purchases may only be an option for particular payment methods used by the purchaser (e.g., when the social purchase system is provided by an account provider or payment service provider that provides those particular payment methods.) The purchaser may select the send button 416 to send a purchase instruction that may includes the payment method provided in the payment method input 404, the payment method authorization provided in the payment method authorization input 406, and in some embodiments the selection of the social purchase selector 408, over the network to the social purchase system provider device. The purchase instruction may also include information or identifiers for the merchant selling the selected item, details about the item, and/or other purchase instruction information known in the art.

In an embodiment in which block 102 has been skipped, when the social purchase selector 408 has been selected, the user may be provided with a social purchase set-up page that is similar to the social purchase set-up page 300 and that allows the purchaser to provide details about the social purchase including the number of positive opinions necessary to authorize the purchase, a time period in which the positive opinions must be received, subgroups of the social network of the purchaser that will be provided the social purchase solicitation to determine whether to authorize the purchase, an intended gift recipient of the purchase for whom communications related to the purchase should be hidden, and/or a variety of other details for the social purchase.

In some embodiments, the purchaser may select a plurality of items and designate those plurality of items as subject to a social purchase in which only one of the plurality of items will be purchased based on a decision by the friends in the social network of the purchaser. For example, the user may select two televisions and include those televisions in a grouped social purchase request that, as described in further detail below, presents the two televisions to friends in the social network of the purchaser for ‘voting’ to determine which of the televisions should be purchased.

The method 400 then proceeds to block 106 where it is determined that the purchase instruction is associated with a social purchase request. In one embodiment, the social purchase request may have been provided in block 102 as discussed above, and at block 106 the social purchase system provider device may determine that an item selected for purchase is subject to a social purchase request by determining that the item selected for purchase falls within one of the social purchase item categories selected on the social purchase set-up page 200 in block 102 of the method 100, is included as a specific item in one of the social purchase item categories selected on the social purchase set-up page 200 in block 102 of the method 100, or is otherwise defined as an item subject to a social purchase (as defined prior to receiving the purchase instruction at block 106 of the method 100.) In another embodiment, block 102 of the method 100 may have been skipped, and the social purchase system provider device may determine that an item selected for purchase is subject to a social purchase request by determining that purchase instruction includes the item selected for purchase along with a social purchase request (e.g., due to the purchaser selecting the social purchase selector 408 on the item purchasing page 400). In yet another embodiment, the social purchase request provided in block 102 may not include the item selected for purchase, but the social purchase system provider device may determine that the item selected for purchase is subject to a social purchase request by determining that purchase instruction includes the item selected for purchase along with a social purchase request (e.g., due to the purchaser selecting the social purchase selector 408 on the item purchasing page 400). While not illustrated, as discussed above the user may select a plurality of items to be subject to a social purchase by, for example, selecting a plurality of items for purchase and then selecting a button similar to the social purchase selector 408 illustrated on the item purchasing page 400.

While referred to as a “purchase instruction”, in some embodiments the purchase instruction of the present disclosure may be considered an “intent to purchase”, as once it is determined that the purchase instruction is associated with a social purchase request, that purchase instruction is “held” and not executed unless approved by the friends designated in the social purchase request, as discussed below.

Referring now to FIGS. 1, 5, and 6, the method 100 then proceeds to block 108 where a social purchase solicitation is provided to friends in the social network of the purchaser. In response to the social purchase system provider device receiving the purchase instruction at block 104 and determining that the purchase instruction is associated with a social purchase request at block 106, the social purchase system provider device provides a social purchase solicitation for display on friend devices through friend profiles according to the social purchase request. For example, the social purchase request that includes the item selected for purchase by the purchaser may also include information or identifiers for friend profiles to which the solicitation request should be sent, and the social purchase system provider device may use the information or identifiers to provide the social purchase solicitation to the friend profiles such that the friends may use friends devices to view the social purchase solicitation.

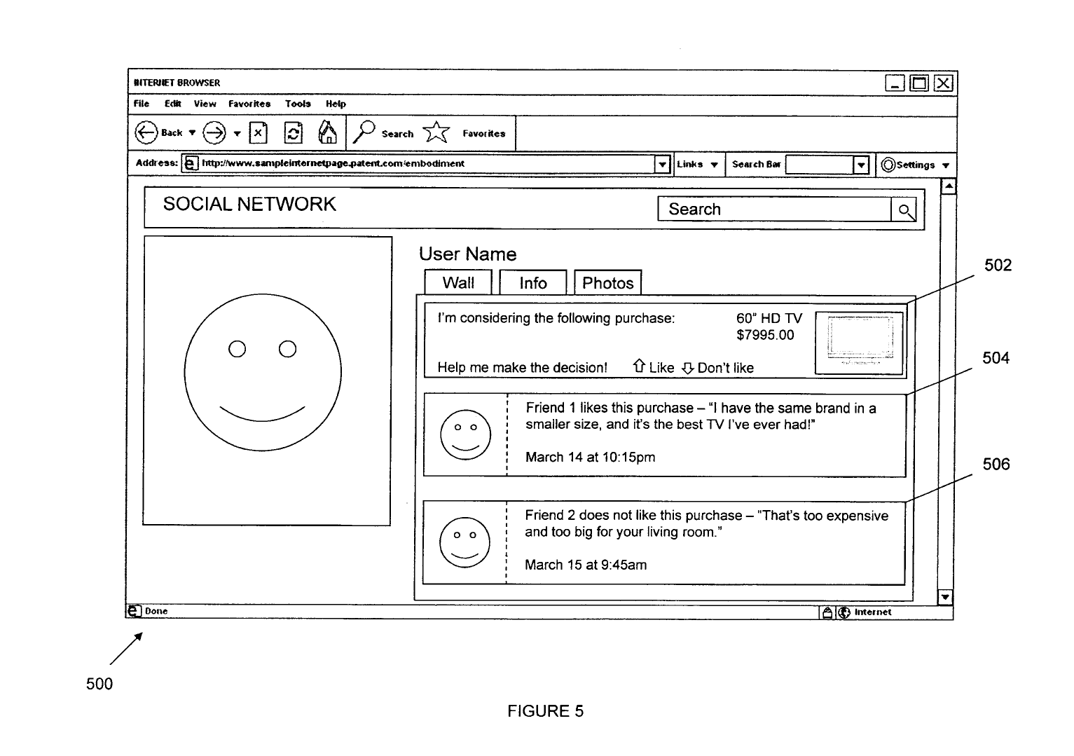

FIG. 5 illustrates a social network profile 500 displaying a social network solicitation. While the social network profile 500 is illustrated as provided on the purchaser profile of the purchaser and displayed on the purchaser device, one of skill in the art will recognize that the social purchase solicitation 500 may be provided on a friend profile of a friend of the purchaser and displayed on a friend device without departing from the scope of the present disclosure. As can be seen in the social network profile 500 illustrated in FIG. 5, the social network solicitation 502 includes a purchase statement (e.g., “I'm considering the following purchase”), along with details of the item included in the purchase instruction (e.g., an item description, an item price, and an item image), and a voting request (e.g., “Help me make the decision!” along with a “like” selector and a “don't like” selector). While one example has been provided, one of skill in the art will recognize that the social purchase solicitation 502 may include a number of features for describing or providing information about the item the purchaser has selected (including, for example, links to item description web pages) and allowing the friend to indicate a positive or negative opinion with regard to the purchaser purchasing the item.

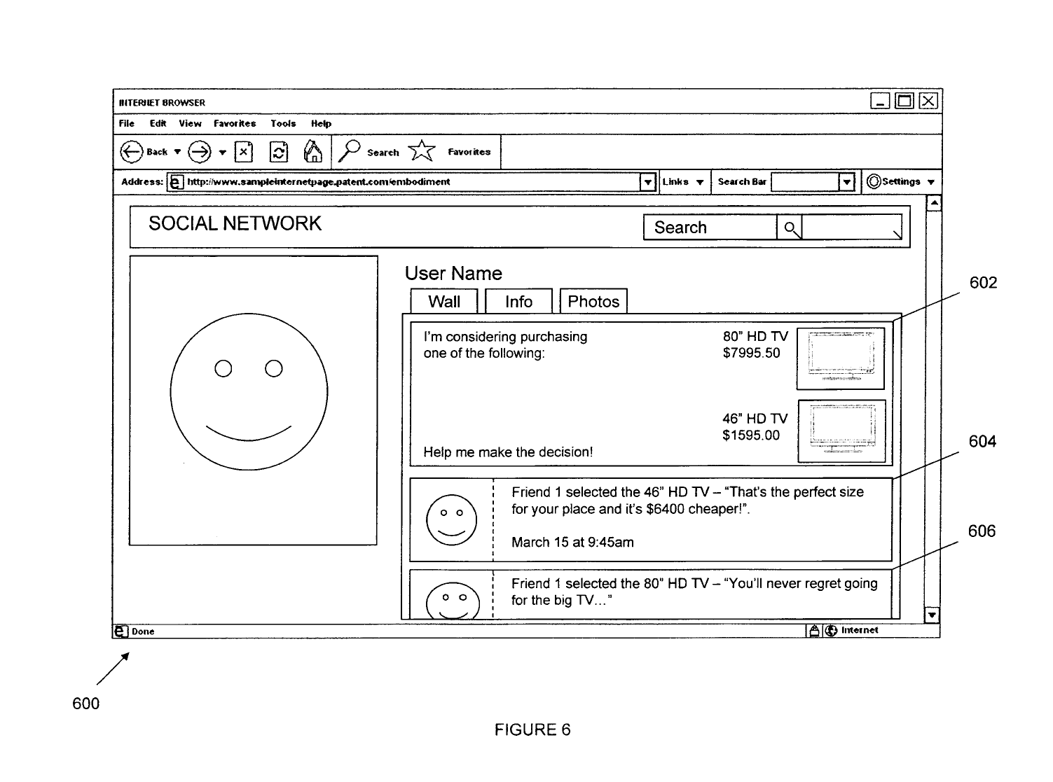

FIG. 6 illustrates a social network profile 600 displaying a social network solicitation. While the social network profile 600 is illustrated as provided on the purchasers profile of the purchaser and displayed on the purchaser device, one of skill in the art will recognize that the social purchase solicitation 600 may be provided on a friend profile of a friend of the purchaser and displayed on a friend device without departing from the scope of the present disclosure. As can be seen in the social network profile 600 illustrated in FIG. 6, the social network solicitation 602 includes a purchase statement (e.g., “I'm considering purchasing one of the following”), along with details of a plurality of items included in the purchase instruction (e.g., item descriptions, item prices, and item images for each respective item subject to the social purchase), and a voting request (e.g., “Help me make the decision!”).

Thus, in response to a purchase instruction being associated with a social purchase request, social purchase solicitations may be provided on friend profiles and displayed on friend devices according to the social purchase request in order to present the item or items selected by the purchaser according to the purchase instruction such that the friends may use their friend profiles to ‘vote’ or otherwise provide their opinion on the item or items.

The method 100 then proceeds to decision block 110 where it is determined whether social purchase opinions provided by friends of the purchaser include a predetermined number of positive opinions. In an embodiment, the social purchase system provider device may monitor the social purchase solicitation provided to the friend profiles for responses (e.g., through the social network.) In some examples, responses may be provided by a voting button such as, for example, a “like” button, a “+1” button, and/or a variety of other social network voting devices known in the art, and those votes may be categorized as positive opinions (i.e., votes “for” an item) or negative opinions (i.e., votes “against” an item). In other examples, comments from friend profiles that are in response to the social purchase solicitation may be reviewed (e.g., by the purchaser) and categorized as positive opinions in support of purchasing an item or negative opinions not in support of purchasing an item. In yet another example, comments from friend profiles that are in response to the social purchase solicitation may be parsed by the social purchase system provider device and analyzed (e.g., using artificial intelligence methods known in the art) to determine whether those comments are positive opinions in support of purchasing an item or negative opinions not in support of purchasing an item.

The social network profile 500 illustrated in FIG. 5 includes a plurality of social purchase opinions 504 and 506 from friend profiles that are in response to the social purchase solicitation 502 and directed to the item selected by the purchaser. The social purchase opinion 504 illustrates a positive opinion that includes a vote (e.g., “Friend 1 likes this purchase”, which may have been provided by selecting the “like” button provided with the social purchase solicitation 502) along with a comment (e.g., “I have the same brand in a smaller size, and it's the best TV I've ever had!” which, as discussed above, may be categorized by the purchaser as a positive opinion or parsed by the social purchase system provider device to be categorized as a positive opinion in the absence of the vote). The social purchase opinion 506 illustrates a negative opinion that includes a vote (e.g., “Friend 2 does not likes this purchase”, which may have been provided by selecting the “don't like” button provided with the social purchase solicitation 502) along with a comment (e.g., “That's too expensive and too big for your living room” which, as discussed above, may be categorized by the purchaser as a negative opinion or parsed by the social purchase system provider device to be categorized as a negative opinion in the absence of the vote).

In some embodiments, the social purchase system provider device may retrieve previously provided social purchase opinions from friends who have not actually responded to the social purchase solicitation provided at block 108 of the method 100. For example, a friend in the social network subgroup associated with the social purchase request may have recently provided a social purchase opinion for an item that is the same as or similar to the item in the social purchase solicitation provided at block 108, but for a different purchaser. In such a situation, the social purchase system provider device may retrieve that social purchase opinion and either provide it as a social purchase opinion for the social purchase solicitation provided at block 108, use that previously provided social purchase opinion to indicate a “sentiment” of the friend about the social purchase solicitation provided in block 108, or otherwise indicate that, while the friend has not responded to the social purchase solicitation provided at block 108, that friend has previously indicated that they felt a certain way (according to the previously provided social purchase opinion) about similar items.

At decision block 110, the social purchase system provider device may monitor the social network solicitation 502 (e.g., by monitoring social purchase opinions from friend profiles that are directed to the item in response to the social network solicitation 502) for the time period specified in the social purchase request. If at any time during the time period, a number of social purchase opinions provided by friend profiles and directed to the item in response to the social network solicitation 502 reaches a predetermined number of positive opinions, the method 100 proceeds to block 112, discussed in further detail below. If the time period passes before a number of social purchase opinions provided by friend profiles and directed to the item in response to the social network solicitation reaches a predetermined number of positive opinions, the method 100 proceeds to block 114, discussed in further detail below.

In another embodiment, the social network profile 600 illustrated in FIG. 6 includes a plurality of social purchase opinions 604 and 606 from friend profiles that are directed to the social purchase solicitation 602. The social purchase opinion 604 illustrates a positive opiniontjat os directed to one of the items in the social purchase solicitation 602 and that includes a vote for that item (e.g., “Friend 1 selected the 46″ HD TV”, which may have been provided by selecting the image of that item) along with a comment directed to the items listed in the social purchase solicitation (e.g., “That's the perfect size for your place and it's $6400 cheaper!” which, as discussed above, may be categorized by the purchaser as a positive opinion directed to a particular item or parsed by the social purchase system provider device to be categorized as a positive opinion directed to a particular item). The social purchase opinion 606 illustrates a positive opinion that is directed to one of the items in the social purchase solicitation and that includes a vote for that item (e.g., “Friend 2 selected the 80″ HD TV”, which may have been provided by selecting the image of that item) along with a comment directed to that item (e.g., “You'll never regret going for the big TV” which, as discussed above, may be categorized by the purchaser as a positive opinion directed to a particular item or parsed by the social purchase system provider device to be categorized as a positive opinion directed to a particular item).

At decision block 110, the social purchase system provider device may monitor the social network solicitation 602 (e.g., by monitoring social purchase opinions from friend profiles directed to particular items in the social network solicitation 602) for the time period specified in the social purchase request. If at any time during the time period, a number of social purchase opinions provided by friend profiles and directed to a particular item in the social network solicitation 602 reaches a predetermined number of positive opinions for that particular item, the method 100 proceeds to block 112, discussed in further detail below. If the time period passes before a number of social purchase opinions provided by friend profiles and directed to a particular item in the social network solicitation 602 reaches a predetermined number of positive opinions directed to any particular item, the method 100 proceeds to block 114, discussed in further detail below.

In response to the determining that the social purchase opinions include a predetermined number of positive opinions at decision block 110, the method 100 proceeds to block 112 where a payment request is sent. In an embodiment, the social purchase system provider device determines that a predetermined number of positive opinions directed to a particular item have been provided by friend profiles through friends devices in response to a social purchase solicitation, and sends a payment request to make a payment from a purchaser payment account to a merchant account associated with the particular item (which may be determined using information or identifiers for the merchant or merchant account that are sent with the purchase instruction.) In one example, the social purchase system provider device may send the payment request automatically and without any further actions from the purchaser (e.g., through their purchaser profile and/or using their purchaser device) in response to determining that a predetermined number of positive opinions have been provided. In another example, upon determining that predetermined number of positive opinions have been provided, the social purchase system provider device may send a social purchase update to the purchaser that informs them that the predetermined number of positive opinions have been provided for an item, and the purchaser may then confirm the purchase (e.g., using a “buy” button included with the social purchase update) such that the payment request is sent at block 112.

In response to the determining that the social purchase opinions do not include a predetermined number of positive opinions at decision block 110, the method 100 proceeds to block 114 where a social purchase update is sent. In an embodiment, the social purchase system provider device may determine that a predetermined number of positive opinions directed to any particular item have not been provided by friend profiles through friends devices in response to a social purchase solicitation (e.g., within a time period defined by the social purchase request) and, in response, sends a social purchase update to the purchaser device to inform the purchaser that their friends have not approved the prospective purchase. In some examples, the method 100 may end at block 114 with the social purchase update informing the purchaser that the selected item will not be purchased, and in some cases the purchaser may be prevented from purchasing an item that has not been approved by their friends according to the social purchase request. In other examples, the social purchase update may give the purchaser an option to purchase the item that was not approved by their friends (e.g., using a “buy” button included with the social purchase update). In such an example, the method 100 may proceed to optional block 116 where a purchase confirmation is received. In an embodiment, the purchaser may select the “buy” button on the social purchase update that instructs the social purchase system provider device to purchase the item that was not approved by the purchaser's friends. The method 100 then proceeds to clock 112 where a payment request is sent in substantially the same manner as discussed above.

In some embodiments, following a determination that the social purchase opinions do not include a predetermined number of positive opinions at decision block 110, the social purchase system provider device may contact the merchant device to inform the merchant that an item from that merchant that was selected by the purchaser was not purchased, and offer to provide an incentive from the merchant to the purchaser to make the a purchase. For example, the social purchase system provider device may use the social purchase opinions to determine why the purchase was not made (e.g., “that TV is too big”, “that TV is too expensive”, etc.), inform the merchant as to why the purchase was not made, and offer to forward purchase incentives (e.g., an offer for a smaller TV, a coupon for a reduction in price, etc.) from the merchant to the purchaser. Thus, the social purchase update provided by the social purchase system provider device to the purchaser device may include merchant incentives provided to the social purchase system provider from the merchant.

In some embodiments, social purchase opinions provided by the friends in the social network subgroup associated with the social network request may not be positive opinions for an item in the social network solicitation, but those social purchase opinions may suggest alternatives to the item or items. In such an embodiment, the social purchase system provider device may determine that a predetermined number of alternative suggestions for a given item have been provided in the social purchase opinions, and then suggest that item to the purchaser for purchase. For example, the social purchase solicitation may include a television as illustrated and described above, and the social purchase opinions provided by the friend profiles may not include positive opinions for that item but may include a predetermined number of alternative suggestions suggesting a different item (e.g., “I'm not a fan of that television manufacturer, but the 50″ television from manufacturer B is a great TV!”). In response to determining that the alternative item has been suggested a predetermined number of times in response to the social purchase solicitation, the social purchase system provider device may suggest the alternative item for purchase to the purchaser (e.g., by providing a link to purchase the alternative item, sending a social purchase update indicating that the alternative item has been suggested a predetermined number of times by friends in the social network of the purchaser, etc.)

Thus, a system and method for providing social purchases has been described that allows a purchaser to select an item or items for social purchase, and then have that item or those items provided to friends in their social network for determination on whether the purchase will be made. In some embodiments, the purchaser may subject an item to a social purchase, and in the event that item is approved by a predetermined number of the purchaser's friends, that item is automatically purchased for the purchaser. In another embodiments, the user may subject a plurality of items to a social purchase, and one of those plurality of items may be approved by the purchaser's friends for purchase (e.g., that item may receive the most ‘votes’ relative to the other items.)

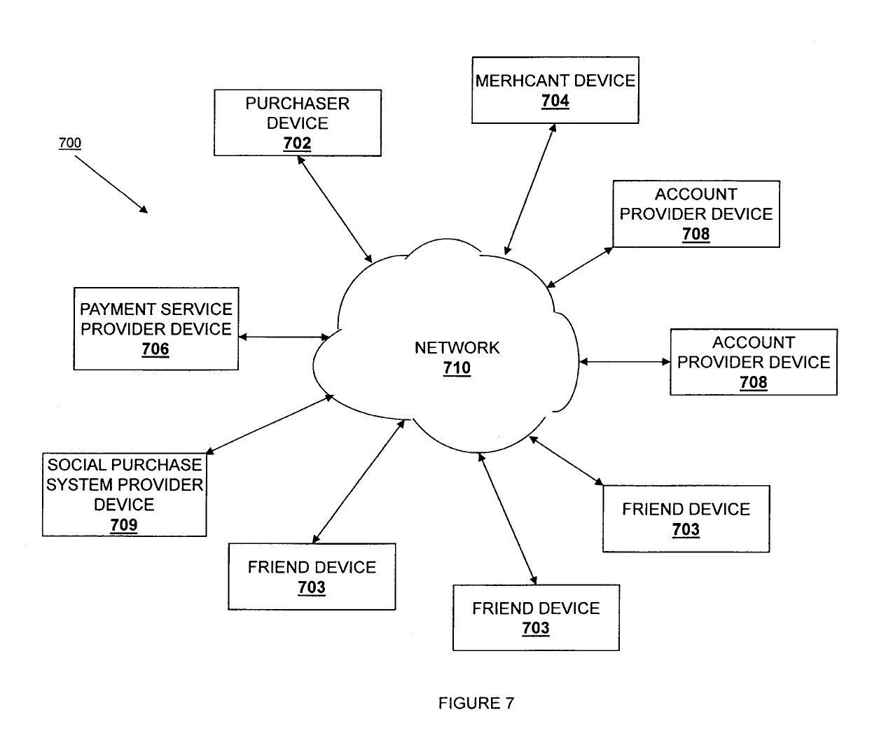

Referring now to FIG. 7, an embodiment of a networked system 700 used in the social purchase system described above is illustrated. The networked system 700 includes a purchaser device 702, a plurality of friend devices 703, a merchant device 704, a payment service provider device 706, a plurality of account provider devices 708, and/or a social purchase system provider device 709 in communication over a network 710. The purchaser device 702 may be the purchaser device operated by the purchaser, discussed above. Any of the friend devices 703 may be the friend devices operated by the friends of the purchaser, discussed above. The merchant device 704 may be the merchant device discussed above and may be operated by the merchant discussed above. The payment service provider device 706 may be the payment service provider device discussed above and may be operated by a payment service provider such as, for example, PayPal Inc. of San Jose, Calif. The account provider devices 708 may be the account provider devices discussed above and may be operated by the account providers discussed above such as, for example, credit card account providers, bank account providers, savings account providers, and a variety of other account providers known in the art. The social purchase system provider device 709 may be the social purchase system provider device operated by the social purchase system provider discussed above, and in some embodiments, may be provided by the purchaser device, the merchant device, the account provider device, the payment service provider device, or third party devices.

The purchaser device 702, the friend devices 703, the merchant device 704, the payment service provider device 706, the account provider devices 708, and/or the social purchase system provider device 709 may each include one or more processors, memories, and other appropriate components for executing instructions such as program code and/or data stored on one or more computer readable mediums to implement the various applications, data, and steps described herein. For example, such instructions may be stored in one or more computer readable mediums such as memories or data storage devices internal and/or external to various components of the system 700, and/or accessible over the network 710.

The network 710 may be implemented as a single network or a combination of multiple networks. For example, in various embodiments, the network 710 may include the Internet and/or one or more intranets, landline networks, wireless networks, and/or other appropriate types of networks.

The purchaser device 702 may be implemented using any appropriate combination of hardware and/or software configured for wired and/or wireless communication over network 710. For example, in one embodiment, the purchaser device 702 may be implemented as a personal computer of a purchaser in communication with the Internet. In other embodiments, the purchaser device 702 may be a smart phone, personal digital assistant (PDA), laptop computer, and/or other types of computing devices.

The purchaser device 702 may include one or more browser applications which may be used, for example, to provide a convenient interface to permit the purchaser to browse information available over the network 710. For example, in one embodiment, the browser application may be implemented as a web browser configured to view information available over the Internet.

The purchaser device 702 may also include one or more toolbar applications which may be used, for example, to provide user-side processing for performing desired tasks in response to operations selected by the purchaser. In one embodiment, the toolbar application may display a user interface in connection with the browser application.

The purchaser device 702 may further include other applications as may be desired in particular embodiments to provide desired features to the purchaser device 702. In particular, the other applications may include a payment application for payments assisted by a payment service provider through the payment service provider device 706. The other applications may also include security applications for implementing user-side security features, programmatic user applications for interfacing with appropriate application programming interfaces (APIs) over the network 710, or other types of applications. Email and/or text applications may also be included, which allow the purchaser to send and receive emails and/or text messages through the network 710. The purchaser device 702 includes one or more purchaser and/or purchaser device identifiers which may be implemented, for example, as operating system registry entries, cookies associated with the browser application, identifiers associated with hardware of the purchaser device 702, or other appropriate identifiers, such as a phone number. In one embodiment, the purchaser identifier or purchaser device identifier may be used by the merchant device 704, the payment service provider device 706 the account provider device 708, and/or the social purchase system provider device 709 to associate the purchaser with a particular account as further described herein.

The merchant device 704 may be maintained, for example, by a conventional or on-line merchant, conventional or digital goods seller, individual seller, and/or application developer offering various products and/or services in exchange for payment to be received conventionally or over the network 710. In this regard, the merchant device 704 may include a database identifying available products and/or services (e.g., collectively referred to as items) which may be made available for viewing and purchase by the purchaser.

The merchant device 704 also includes a checkout application which may be configured to facilitate the purchase by the purchaser of items. The checkout application may be configured to accept payment information from the user through the purchaser device 702, the account provider through the account provider device 708, the payment service provider through the payment service provider device 706, and/or the social purchase system provider through the social purchase system provider device 709 over the network 610.

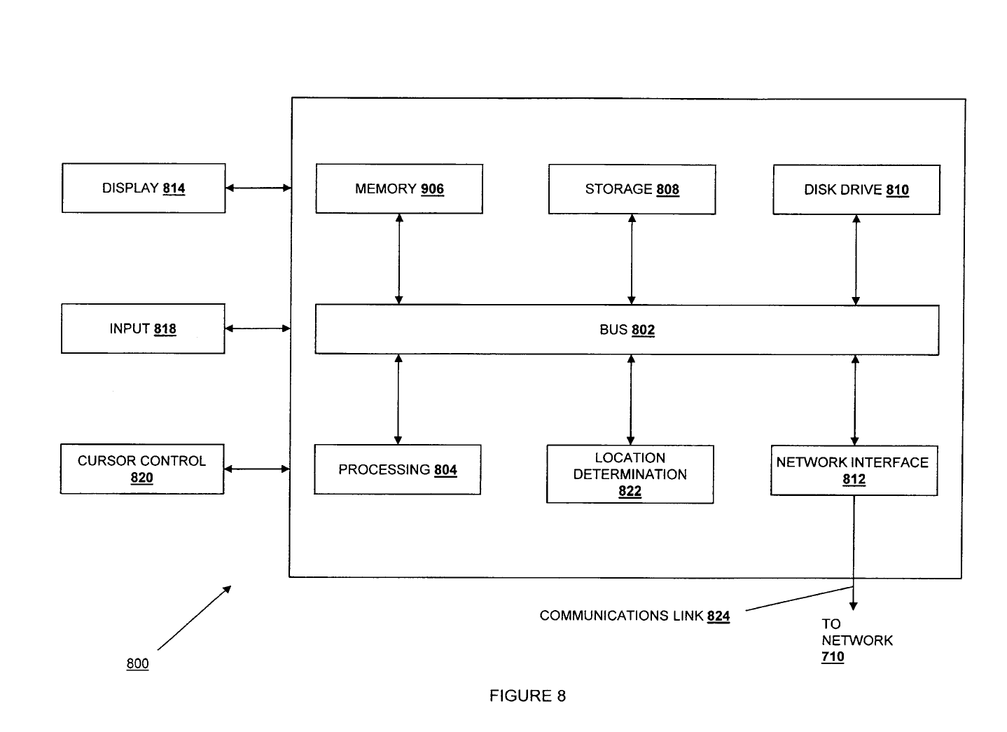

Referring now to FIG. 8, an embodiment of a computer system 800 suitable for implementing, for example, the purchaser device 702, the friend devices 703, the merchant devices 704, the payment service provider device 706, the account provider device 708, and/or the social purchase system provider device 709, is illustrated. It should be appreciated that other devices utilized by purchasers, friends, merchants, payment service providers, account providers, and/or social purchase system providers in the social purchase system discussed herein may be implemented as the computer system 800 in a manner as follows.

In accordance with various embodiments of the present disclosure, computer system 800, such as a computer and/or a network server, includes a bus 802 or other communication mechanism for communicating information, which interconnects subsystems and components, such as a processing component 804 (e.g., processor, micro-controller, digital signal processor (DSP), etc.), a system memory component 806 (e.g., RAM), a static storage component 808 (e.g., ROM), a disk drive component 810 (e.g., magnetic or optical), a network interface component 812 (e.g., modem or Ethernet card), a display component 814 (e.g., CRT or LCD), an input component 818 (e.g., keyboard, keypad, or virtual keyboard), a cursor control component 820 (e.g., mouse, pointer, or trackball), and/or a location determination component 822 (e.g., a Global Positioning System (GPS) device as illustrated, a cell tower triangulation device, and/or a variety of other location determination devices known in the art.) In one implementation, the disk drive component 810 may comprise a database having one or more disk drive components.

In accordance with embodiments of the present disclosure, the computer system 800 performs specific operations by the processor 804 executing one or more sequences of instructions contained in the memory component 806, such as described herein with respect to the purchaser device 702, the friend devices 703, the merchant devices 704, the payment service provider device 706, the account provider device 708, and/or the social purchase system provider device 709. Such instructions may be read into the system memory component 806 from another computer readable medium, such as the static storage component 808 or the disk drive component 810. In other embodiments, hard-wired circuitry may be used in place of or in combination with software instructions to implement the present disclosure.

Logic may be encoded in a computer readable medium, which may refer to any medium that participates in providing instructions to the processor 804 for execution. Such a medium may take many forms, including but not limited to, non-volatile media, volatile media, and transmission media. In several embodiments, the computer readable medium is non-transitory. In various implementations, non-volatile media includes optical or magnetic disks, such as the disk drive component 810, volatile media includes dynamic memory, such as the system memory component 806, and transmission media includes coaxial cables, copper wire, and fiber optics, including wires that comprise the bus 802. In one example, transmission media may take the form of acoustic or light waves, such as those generated during radio wave and infrared data communications.

Some common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, carrier wave, or any other medium from which a computer is adapted to read.

In various embodiments of the present disclosure, execution of instruction sequences to practice the present disclosure may be performed by the computer system 800. In various other embodiments of the present disclosure, a plurality of the computer systems 800 coupled by a communication link 824 to the network 710 (e.g., such as a LAN, WLAN, PTSN, and/or various other wired or wireless networks, including telecommunications, mobile, and cellular phone networks) may perform instruction sequences to practice the present disclosure in coordination with one another.

The computer system 800 may transmit and receive messages, data, information and instructions, including one or more programs (i.e., application code) through the communication link 824 and the network interface component 812. The network interface component 812 may include an antenna, either separate or integrated, to enable transmission and reception via the communication link 824. Received program code may be executed by processor 804 as received and/or stored in disk drive component 810 or some other non-volatile storage component for execution.

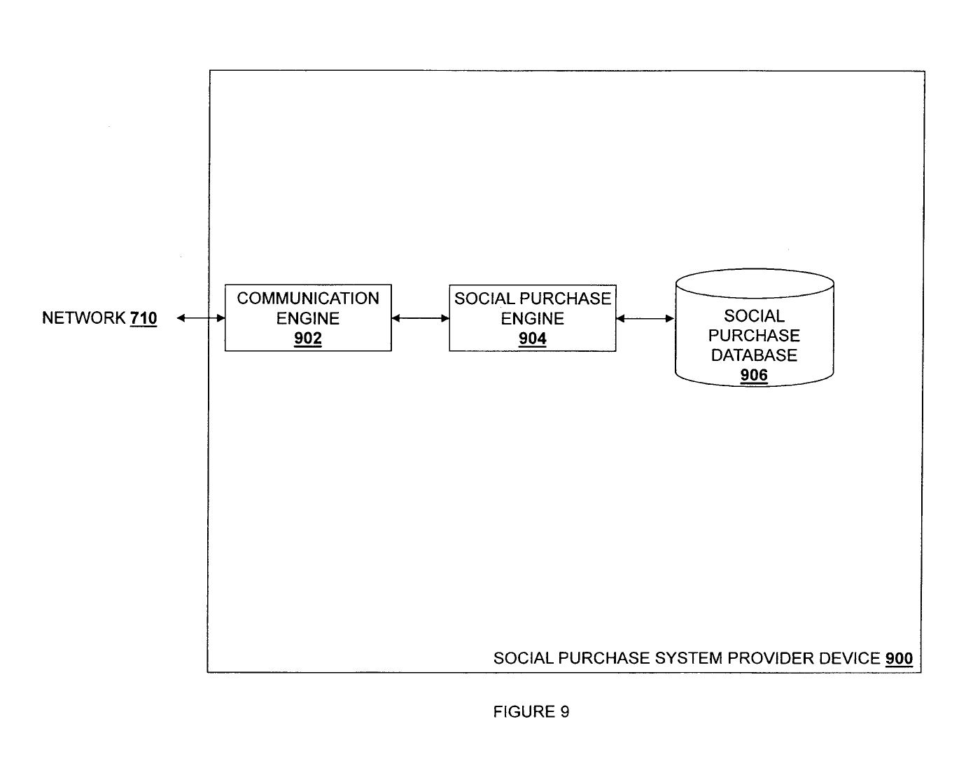

Referring now to FIG. 9, an embodiment of a social purchase system provider device 900 is illustrated. In an embodiment, the device 900 may be the purchaser device 702, the merchant devices 704, the payment service provider device 706, the account provider device 708, and/or a device operated by another entity. The device 900 includes a communication engine 902 that is coupled to the network 710 and to an social purchase engine 904 that is coupled to a social purchase database 906. The communication engine 902 may be software or instructions stored on a computer-readable medium that allows the device 900 to send and receive information over the network 710. The social purchase engine 904 may be software or instructions stored on a computer-readable medium that allow the device 900 to receive social purchase requests, store social purchase requests in the social purchase database 906, receive purchase instructions, determine purchase instructions are associated with social purchase requests, provide social purchase solicitations, monitor social purchase solicitations, provide social purchase updates, send payment requests, and provide any of the other functionality that is discussed above. While the database 906 has been illustrated as located in the device 900, one of skill in the art will recognize that it may be connected to the social purchase engine 904 through the network 710 without departing from the scope of the present disclosure.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the scope of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software, in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. For example, the above embodiments have focused on purchasers and merchants; however, a purchaser or other payment account holder can pay, or otherwise interact with any type of recipient, including charities and individuals. The purchase does not have to involve a item or service, but may be a loan, a charitable contribution, a gift, etc. Thus, merchants as used herein can also include charities, individuals, and any other entity or person that may receive a payment from a purchaser. Having thus described embodiments of the present disclosure, persons of ordinary skill in the art will recognize that changes may be made in form and detail without departing from the scope of the present disclosure. Thus, the present disclosure is limited only by the claims.

What is claimed is:

1. A social purchase system, comprising:
a non-transitory memory storing information associated with a purchaser payment account and information associated with a social network that includes a purchaser profile identifier and a plurality of friend profile identifiers that are connected in the social network; and
one or more hardware processors coupled to the memory and operable to read instructions from the memory to perform the steps of:
receiving a purchase instruction from a purchaser device associated with the purchaser profile identifier, wherein the purchase instruction includes a first item and merchant information associated with the first item;
determining that the purchase instruction is associated with a social purchase request;
providing a social purchase solicitation for display on a plurality of friend devices associated with the plurality of friend profile identifiers, wherein the social purchase solicitation includes the first item;
monitoring the social purchase solicitation for social purchase opinions directed to the first item by the plurality of friend devices associated with the plurality of friend profile identifiers; and
sending a payment request to make a payment from the purchaser payment account to a merchant account determined using the merchant information in response to the social purchase opinions from the plurality of friend devices including a predetermined number of positive opinions directed to the first item.

2. The system of claim 1, wherein the purchase instruction includes a plurality of items including the first item.

3. The system of claim 1, wherein the one or more processors are operable to read instructions from the memory to perform the steps of:
receiving the social purchase request from the purchaser device prior to receiving the purchase instruction, wherein the social purchase request includes at least one social purchase item category; and
storing the social purchase request in the non-transitory memory, wherein the determining that the purchase instruction is associated with a social purchase request includes determining that the first item in the purchase instruction is included in the at least one social purchase item category in the social purchase request.

4. The system of claim 3, wherein the social purchase request includes the predetermined number of positive opinions and a time period, and wherein the payment request to make the payment from the purchaser account to the merchant account is sent in response to the social purchase opinions including the predetermined number of positive opinions that are directed to the item and that have been provided within the time period.

5. The system of claim 1, wherein the social purchase request is received with the purchase instruction.

6. The system of claim 1, wherein the one or more processors are operable to read instructions from the memory to perform the steps of:
determining that the social purchase opinions include a predetermined number of positive opinions directed to the item and, in response, automatically sending the payment request to make the payment from the purchaser account to the merchant account without any further input from the purchaser device.

7. A method for providing a social purchase, comprising:
receiving a purchase instruction associated with a purchaser social network profile stored in a database, wherein the purchase instruction includes a first item and a merchant associated with the first item;
determining that the purchase instruction is associated with a social purchase request;
providing a social purchase solicitation for display with a plurality of friend social network profiles that are stored in the database and that are connected to the purchaser social network profile through a social network, wherein the social purchase solicitation includes the first item;
monitoring the social purchase solicitation for social purchase opinions directed to the first item by the plurality of friend social network profiles; and
sending a payment request to make a payment from a purchaser account associated with the purchaser social network profile to a merchant account of the merchant in response to the social purchase opinions from the plurality of friend social network profiles including a predetermined number of positive opinions directed to the first item.

8. The method of claim 7, wherein the purchase instruction includes a plurality of items including the first item.

9. The method of claim 7, further comprising:
receiving the social purchase request associated with the purchaser social network profile prior to receiving the purchase instruction, wherein the social purchase request includes at least one social purchase item category; and
storing the social purchase request, wherein determining that the purchase instruction is associated with a social purchase request includes determining that the first item in the purchase instruction is included in the at least one social purchase item category in the social purchase request.

10. The method of claim 9, wherein the social purchase request includes the predetermined number of positive opinions and a time period, and wherein the payment request to make the payment from the purchaser account associated with the purchaser social network profile to the merchant account of the merchant is sent in response to the social purchase opinions including the predetermined number of positive opinions that are directed to the item and that have been provided within the time period.

11. The method of claim 10, further comprising:
determining that the predetermined number of positive opinions directed to the item have not been provided within the time period;
providing a social purchase update for display with the purchaser social network profile, wherein the social purchase update indicates that the first item will not be purchased.

12. The method of claim 7, wherein the social purchase request is received with the purchase instruction.

13. The method of claim 7, further comprising:
determining that the social purchase opinions include a predetermined number of positive opinions directed to the item and, in response, automatically sending the payment request to make the payment from the purchaser account associated with the purchaser social network profile to the merchant account of the merchant without any further input associated with the purchaser social network profile.

14. A non-transitory machine-readable medium comprising a plurality of machine-readable instructions which, when executed by one or more processors, are adapted to cause the one or more processors to perform a method comprising:
receiving a purchase instruction from a purchaser device, wherein the purchase instruction includes a first item and a merchant identifier associated with the first item;
determining that the purchase instruction is associated with a social purchase request;
providing a social purchase solicitation for display on a plurality of friend devices that are connected to the purchaser device through a social network using social network profiles, wherein the social purchase solicitation includes the first item;
monitoring the social purchase solicitation for social purchase opinions directed to the first item by social network profiles associated with the plurality of friend devices; and
sending a payment request to make a payment from a purchaser account associated with the purchaser device to a merchant account associated with the merchant identifier in response to the social purchase opinions by the social network profiles associated with the plurality of friend devices including a predetermined number of positive opinions directed to the first item.

15. The non-transitory machine-readable medium of claim 14, wherein the purchase instruction includes a plurality of items including the first item.

16. The non-transitory machine-readable medium of claim 14, wherein the method further comprises:
receiving the social purchase request from the purchaser device prior to receiving the purchase instruction, wherein the social purchase request includes at least one social purchase item category; and
storing the social purchase request, wherein the determining that the purchase instruction is associated with a social purchase request includes determining that the first item in the purchase instruction is included in the at least one social purchase item category in the social purchase request.

17. The non-transitory machine-readable medium of claim 16, wherein the social purchase request includes the predetermined number of positive opinions and a time period, and wherein the payment request to make the payment from the purchaser account associated with the purchaser device to the merchant account associated with the merchant identifier is sent in response to the social purchase opinions by the social network profiles associated with the plurality of friend devices including the predetermined number of positive opinions that are directed to the item and that have been provided within the time period.

18. The non-transitory machine-readable medium of claim 17, wherein the method further comprises:
determining that the predetermined number of positive opinions directed to the item have not been provided within the time period;
providing a social purchase update for display on the purchaser device, wherein the social purchase update indicates that the first item will not be purchased.

19. The non-transitory machine-readable medium of claim 14, wherein the social purchase request is received with the purchase instruction.

20. The non-transitory machine-readable medium of claim 14, wherein the method further comprises:
determining that the social purchase opinions include a predetermined number of positive opinions directed to the item and, in response, automatically sending the payment request to make the payment from the purchaser account associated with the purchaser device to the merchant account associated with the merchant identifier without any further input from the purchaser device.
